(19) United States
(12) Patent Application Publication
(10) Pub. No.: US 2008/0078244 A1
(43) Pub. Date: Apr. 3, 2008

(54) Spacer for Coaxial Inner Conductor

(76) Inventor: Juergen Dietmeier, Hausach (DE)

Correspondence Address: FAY KAPLUN & MARCIN, LLP, 15O BROADWAY, SUITE 702, NEW YORK, NY, 10038, US

(21) Appl. No.: 11/855,307

(22) Filed: Sep. 14, 2007

Related U.S. Application Data
(60) Provisional application No. 60/847,697, filed on Sep. 28, 2006.

(30) Foreign Application Priority Data
Sep. 28, 2006 (DE) 10 2006 045 940.7

(51) Int. Cl. G01F 23/26; H01B 13/20

(52) U.S. Cl. 73/304 C; 29/828

(57) ABSTRACT

A spacer element for a spacer for a coaxial inner conductor for a measuring device is stated. The spacer element comprises a plate with a circular outside contour and a U-shaped incision, wherein the circular outside contour comprises an external radius, and wherein the U-shaped incision comprises a semicircular region with an internal radius. Furthermore, the plate comprises a surface region, wherein the outside contour and the U-shaped incision are designed such that when at least two spacer elements are arranged such that the circular outside contours are essentially in alignment and such that in each case a surface region of one plate rests against a surface region of the other plate, a spacer with a circular opening is formed, which opening comprises the internal radius of the semicircular region. In this arrangement the outside contour and the opening form concentric circles.

### RELATED APPLICATIONS

This application claims the benefit of the filing date of U.S. Provisional Patent Application Ser. No. 60/847 967 filed Sep. 28, 2006, and German Patent Application Serial No. 10 2006 045 940.7 filed Sep. 28, 2006, the disclosures of which are hereby incorporated herein by reference.

### TECHNICAL FIELD

The present invention relates to the field of coaxial conductors for fill-level measuring devices. In particular, the present invention relates to a spacer element for a spacer for a coaxial conductor for a fill-level measuring device, to a spacer for a coaxial conductor for a fill-level measuring device, to a coaxial conductor for a fill-level measuring device and to a method for constructing a coaxial conductor for a fill-level measuring device.

### BACKGROUND INFORMATION

In measuring devices, for example for fill-level measuring, coaxial lines are frequently used to guide high-frequency electromagnetic waves. These may be lines that comprise an outer conductor and an inner conductor, wherein for interference-free and low-attenuation guidance of the electromagnetic waves the inner conductor along its entire length may be guided so as to be as precisely centred as possible relative to the outer conductor.

In particular in measuring devices for fill-level measuring, for example according to the time domain reflection method, it should be ensured that the interior of the coaxial conductor remains free. Today this may be most often achieved in that the space between the inner conductor and the outer conductor comprises a spacer spaced apart along the inner conductor. To this effect the inner conductor may be spaced with a spacer that is secured by means of a securing ring.

Furthermore, a spacer may be slid onto an inner conductor and may be affixed by means of elastic clamping.

From printed publication U.S. Pat. No. 6,588,272 an inner conductor is known which is centred by means of a spacer.

However, the clamping effect may be lost due to age, temperature cycles and/or damage to the mounting material as a result of aggressive feed material. There may therefore be a danger of the spacer becoming displaced.

Since a coaxial conductor for measuring a fill level may be arranged in a container, vibrations that arise in the container, for example due to vibration devices or agitating apparatuses, may lead to material fatigue at the lead-in position and ultimately to the inner bar breaking off.

Furthermore, the manufacture of a coaxial conductor comprising a spacer that may be affixed to the inner conductor may require a plural number of expensive and cost-intensive production steps, in particular when securing spring washers are used.

### SUMMARY OF THE INVENTION

Accordingly, the following are stated: a spacer element for a spacer for a coaxial inner conductor for a fill-level measuring device, a spacer for a coaxial inner conductor for a fill-level measuring device, a coaxial conductor and a method for constructing a coaxial conductor by means of a spacer element.

According to an exemplary embodiment of the present invention, a spacer element for a spacer for a coaxial inner conductor for a fill-level measuring device may be created. The spacer element has a plate with an essentially circular outside contour and a U-shaped incision. The circular outside contour has an external radius, and the U-shaped incision has a semicircular region that may be defined by an internal radius.

This may provide for an easily installable spacer for a coaxial conductor.

The plate represents the basic body of the spacer element and comprises a surface region, wherein the outside contour and the U-shaped incision are designed such that when at least two spacer elements are arranged one on top of the other the circular outside contours are essentially in alignment. In this arrangement the spacer elements are designed such that they form a spacer with a circular outside contour, wherein no parts of the spacer project beyond a predeterminable radius.

Moreover, in the formation of the spacer the plate surfaces are placed one on top of the other such that a surface region of the one plate rests against the surface region of the other plate. By arranging the U-shaped incisions in a stacked manner, in the middle of an imaginary projection onto one plane, which may be parallel in relation to the spacer elements, a circular opening in the spacer may be formed. The circular opening has the internal radius of the semicircular region and forms a concentric circle with the outside contour.

By means of this design of the spacer elements, which when a multitude of spacer elements may be placed one on top of the other complement each other to form a spacer with a circular outside contour, it may be made possible that a spacer by lateral sliding of the multitude of spacer elements onto an inner conductor of a coaxial line complements itself to form a circular spacer. Such an assembled spacer may be arrangeable in a groove of an inner conductor so that displacement of the spacer along a longitudinal axis of the inner conductor may be prevented. In this arrangement the spacer that may be formed may not be fully filled with material of the spacer. For the purpose of conducting liquids, openings may be present.

The individual spacer elements may functionally complement each other such that they support an inner conductor in the interior of an outer conductor. They may support the inner conductor against the outer conductor in such a way that when several spacers are arranged along a coaxial conductor that extends along the longitudinal direction of the inner conductor, the inner conductor may be concentrically held. The coaxial conductor may be formed by the outer conductor, the inner conductor and the spacer.

In an installed or assembled state the outer conductor may exert a force onto the spacer elements in the direction of the inner conductor so that the spacer may be held together. In this arrangement the spacer elements may support the inner conductor in all directions such that in the installed state any radial movement of the inner conductor may be prevented.

The outer conductor may, for example, be a tube made of a conductive material, or a tube comprising a conductive inner coating. The inner conductor may be a bar made of a conductive material, or a bar comprising a conductive coating. Furthermore, the inner conductor may also be tubular in shape. In spite of its non-solid design the spacer may support the bar in the interior of the outer conductor in all directions. To this effect the spacer elements may complement each other correspondingly.

By means of the U-shaped incisions a single spacer element may be affixed by laterally being slid onto the inner conductor. Consequently the installation of the coaxial line may be simplified and accelerated.

Furthermore, parts, in particular the spacer elements, may not be lost after having been slid into the tube, because on the one hand they are held together by means of the outer conductor, and on the other hand they may be prevented from sliding in axial direction by means of a groove in the inner conductor.

Moreover, the material of the surrounding parts may be selected at will. In other words this means that in the selection of the material of the outer conductor and the inner conductor there may be no need to consider the material of any additionally required securing ring or other fastening means, for example in order to prevent corrosion.

Since by means of sliding the spacer elements onto the inner conductor it may be possible to prevent having to manufacture the spacer elements from an elastic plastic in order to implement a snap-in function, the spacer elements may be producible from some non-conductive material other than plastic. By adapting the geometric dimensions of the spacer elements, various coaxial conductor geometries may be used. For example, coaxial conductors where the outer conductors and the inner conductors have been produced by different manufacturers may be assembled to form a coaxial line.

The spacer elements may be producible by milling or pressing.

According to another exemplary embodiment of the present invention, a spacer for a coaxial inner conductor for a measuring device may be created. This spacer comprises a multitude of spacer elements. To this effect at least two spacer elements are arranged such that the circular external diameters are essentially in alignment. The spacer elements may thus at least in part rest against the circular internal diameter or the internal surface area of a cylindrical tube.

When assembling the spacers, in each case a surface region of a plate comes to rest against the surface region of the other plate. In this arrangement the multitude of spacer elements complement each other to form an individual spacer such that the spacer comprises a circular outside contour. Furthermore, in the middle the spacer comprises a circular opening that may be concentric in relation to the circular outside contour.

It may thus be avoided for a spacer to have to be arranged so as to be fixed on the inner conductor of a coaxial line by means of securing rings or some other additional holding components.

According to a further aspect of the present invention, a coaxial conductor for a measuring device may be stated, which coaxial conductor comprises a spacer, which comprises a multitude of spacer elements, an outer conductor and an inner conductor. The inner conductor may be held in the interior of the outer conductor by means of the spacer. In this arrangement the circular outside contours of the spacer elements complement each other such that the inner conductor in concrete terms may be held in the interior of the outer conductor like the hub of a wheel by means of spokes. In this arrangement the individual outside contours may prevent a direction of movement in a two-dimensional plane perpendicular in relation to the inner conductor, i.e. in radial direction, whereas axial movement of the inner conductor including the spacer may be possible. In this way the design of the arrangement may, for example, be simplified, and the inner conductor with the spacer may simply be inserted into the outer conductor.

According to yet another exemplary embodiment of the present invention, a method for constructing a coaxial conductor by means of a spacer element may be created. The method comprises various steps. First a first spacer element may be affixed to an inner conductor, in particular to a groove of the inner conductor. Subsequently one, or a multitude of, further spacer element(s) may be affixed to the inner conductor and in particular to the groove of the inner conductor such that the outside contours of the spacer elements are in alignment.

The notion of the spacer elements being in alignment may also mean that the plurality of the spacer elements complement each other such that a spacer element may be created which supports the inner conductor in all spatial directions. In this arrangement the inner conductor may be enclosed and fixed in the semicircular regions of the U-shaped incisions of the spacer elements. After the spacer has been assembled, the inner conductor with the spacer element may be inserted into the outer conductor so that the outer conductor prevents the spacer elements from falling apart in radial direction. In this arrangement the groove on the inner conductor may prevent axial displacement of the spacer elements along the inner conductor.

Below, the invention is described in relation to the spacer elements. These embodiments correspondingly apply to the spacer, to the coaxial conductor for a fill-level measuring device, and to the method.

According to an exemplary embodiment of the present invention, a spacer element may be provided whose plate comprises a thickness, wherein the thickness may be not greater than the external radius. Thus a narrow spacer element may be created. A narrow spacer element may reduce the extent of boundary surfaces and thus the incidence of measuring errors. A boundary surface may arise at a point of discontinuity, for example at a spacer element inserted in the waveguide. A boundary surface may lead to a change in the wave impedance, as a result of which reflections may arise that may impair the measuring process.

According to a further exemplary embodiment of the present invention, the plate of a spacer element comprises a further opening.

In contrast to a completely filled spacer element, the flow of a liquid between the inner conductor and the outer conductor of the coaxial line may be admitted in particular in the case where the individual spacer elements are completely covered.

According to yet another exemplary embodiment of the present invention, a spacer element may be created in which the further opening may be arranged such that when a multitude of spacer elements are arranged together, the further opening forms a passage for the liquid to be measured.

In order to, for example, determine a fill level it may be necessary for the liquid within the coaxial line to be able to become evenly distributed. In this way precise measuring of the fill level of the liquid may be supported.

According to yet another aspect of the present invention, the opening may be arranged in an edge region of the spacer element.

By means of a clever arrangement of several spacer elements it may be possible to centre the inner conductor without this requiring a spacer that may be completely filled with material in order to prevent the inner conductor from moving in radial direction in the outer conductor. By means of a spoke-like arrangement the movement of the inner conductor in the two possible directions of a plane arranged in radial direction perpendicularly in relation to the inner conductor may be prevented by the spacer element, although gaps may be present in the spacer. If the openings or gaps are located in an edge region of the spacer, a liquid that enters the interior of the coaxial conductor from an opening in the outer conductor may advance in axial direction of the coaxial line through this opening.

According to yet a further exemplary embodiment of the present invention, the spacer element comprises an anti-rotation device. In this design the anti-rotation device may be arranged on the circular region of the U-shaped incision such that when the two plates are arranged one on top of the other the anti-rotation device engages the U-shaped incision of the respective other plate such that any rotation movement of a multitude of plates relative to each other may be essentially prevented.

By resting the circular section of the U-shaped incision against the inner conductor, a rotation movement of the spacer element around the inner conductor may be possible. Since the spacer elements complement each other to form a spacer in such a way that essentially any movement in the radial main directions may be prevented, the position of the spacer elements relative to each other may be decisive. Therefore an anti-rotation device of the spacer elements may prevent any rotation movement of the multitude of spacer elements relative to each other on the inner conductor from occurring.

According to yet another exemplary embodiment of the present invention, the plate, and in particular the spacer element, may be mirror-symmetrical in design.

The mirror-symmetrical design on a mirror axis may make it possible that in the case of rotation on the mirror axis by 180° and corresponding rotation by 180° on an axis that extends perpendicularly through the centre of the plate, a spacer element arises that may be clipped onto the inner conductor from a side that differs from that of the spacer element that has not been rotated on the axes. In this arrangement the two spacers complement each other and may interlock.

According to yet another exemplary embodiment of the present invention, the plate, and in particular the spacer element, may be made from a material with a relative permittivity εᵣ in a range from 1.5 to 80, wherein the range boundaries are to be included. The permittivity ε of a material may be obtained by multiplying the electrical field constant ε₀ by the relative permittivity εᵣ. In particular, the range of the relative permittivity εᵣ may extend from 1.5 to 50.

Propagation of an electromagnetic wave in a coaxial line may take place with less hindrance if a material with a lower relative permittivity εᵤ may be used.

For example, aluminium oxide ceramics or steatite may be such a material with a lower relative permittivity εᵣ. Ceramics may be used at high temperatures at which the use of an elastic plastic material may be no longer possible. A spacer element made from ceramics may thus be suitable for applications at temperatures where an elastic plastic holder does not function.

Thus, a spacer element made from a ceramic material, for example an aluminium oxide ceramic material, may be used in a temperature range of between minus 273° Celsius and 1000° Celsius. A further possible range of application may be between 400° Celsius and 1200° Celsius.

After the sintering process and prior to firing, ceramic components may be processed by milling, drilling or pressing, so that the U-shape of the incision may be advantageous. Furthermore, ceramics may have good chemical resistance, wherein in particular high-purity aluminium oxide ceramics make it possible to use the coaxial line in conjunction with chemically corrosive materials.

According to yet another exemplary embodiment of the present invention, a spacer element may be created, wherein the circular outside contour may be formed by means of four segments of a circle. These segments of a circle may be arranged in the shape of a clover leaf.

By means of the segments of a circle, support in all the radial spatial directions may be achievable if said segments of a circle are arranged at a constant angle. It may thus also be possible to save materials without permitting any displacement of the inner conductor in radial direction.

According to a further exemplary embodiment of the present invention, a spacer element may be stated, wherein the semicircular region of the U-shaped incision corresponds to the external radius of an inner conductor. By means of roughening of, or providing an adhesive coating on, the interior surfaces that are in contact with the inner conductor, or by means of roughening of, or providing an adhesive coating on, the corresponding locations of the inner conductor, with the application of corresponding contact pressure to the inner conductor, displacement of the spacer element along the inner conductor may be prevented.

By matching the semicircular region to the internal radius of an inner conductor, in particular to a groove in the inner conductor, it may be possible to space the inner conductor apart from the outer conductor by means of the spacer element.

Below, the invention is described in relation to the coaxial conductor. This description analogously applies to the spacer element, the spacer and the method for constructing a coaxial conductor by means of a spacer element.

According to a further exemplary embodiment of the invention, the outer conductor may be tubular.

The tubular outer conductor may make it possible to hold together the spacer elements in radial direction. In addition, the tubular outer conductor prevents the spacer elements from spreading in radial direction.

According to yet another exemplary embodiment of the present invention, the spacer elements are secured against radial displacement by means of the outer conductor.

Because the outer conductor holds the spacer elements together, not only may the inner conductor be centrically held in the outer conductor, but the spacer may be also held together such that the spacer elements may be prevented from falling apart.

According to yet another exemplary embodiment of the present invention, the inner conductor comprises a groove.

The length of the groove may, for example, be a multiple of the thickness of a spacer element. In this way it may be ensured that displacement of the spacer, which comprises several spacer elements, in axial direction may be prevented.

For example, the length of the groove may correspond to the thickness of a spacer, or to double the thickness of a spacer element in cases where the spacer comprises two spacer elements. If the length of the groove equals the thickness of a spacer, the adjacent spacer elements rest against an edge of the groove and in this way may be secure, on the inner conductor, from any axial displacement.

By means of the groove it is also possible to define the installed position of the spacers, and in particular of the spacer elements, in longitudinal direction of the coaxial line. By means of the groove it may be also possible to prevent any displacement of the spacer along the axial direction of the coaxial line when the inner conductor may be inserted into the outer conductor.

Moreover, the formed coaxial line may be secured against vibration by means of the groove. Consequently no further elements, such as securing rings or spring washers may be required for assembling the coaxial conductors.

In addition, by means of the groove, tilting of the spacer elements from the plane perpendicular in relation to the axial direction of the inner conductor may be prevented. Furthermore, it may be possible to prevent the spacer elements from being lost after their insertion into the tube.

According to yet another exemplary embodiment of the present invention, the outer conductor comprises an opening. By means of the opening, in particular of a multitude of openings, it may be possible for a liquid that may be to be measured to enter the interior of the coaxial conductor and to evenly spread in the interior. It may thus be ensured that the fill level in the interior of the coaxial line corresponds to the fill level on the exterior, for example in a container. Consequently measuring accuracy may be enhanced.

According to yet another exemplary embodiment of the present invention, the opening in the outer conductor may be arranged such that it may be not covered by a spacer. By means of the relative position of the groove in the inner conductor when compared to the opening in the outer conductor in relation to a common point of reference, the location of installation of the spacer element in the interaction with the spacer elements may be determined such that the spacer elements do not come to rest in front of the opening.

According to a further exemplary embodiment of the present invention, a fill-level measuring device with a spacer element or with a spacer or with a coaxial line comprising a spacer may be stated, wherein the fill-level measuring device is selected from the group of fill-level measuring devices comprising: a fill-level measuring device that operates according to the TDR (Time Domain Reflectometry) method, a measuring device for interface acquisition, a capacitively operating fill-level measuring device, and a level-detection measuring device that operates according to the TDR method or capacitively. For the purpose of interface acquisition the coaxial conductor may be arranged on a float. The float may float on the layer of liquid whose thickness may be to be determined. Consequently the depth to which the coaxial conductor dips into the liquid to be determined may be varied depending on the liquid level. Interface acquisition may, for example, be carried out for determining the liquid level of oil on water.

### BRIEF DESCRIPTION OF THE DRAWINGS

Below, advantageous exemplary embodiments of the present invention are described with reference to the figures:

FIG. 1 shows a diagrammatic three-dimensional view of a spacer element according to an exemplary embodiment of the present invention.

FIG. 2 shows a bottom view of a spacer element according to an exemplary embodiment of the present invention.

FIG. 3 shows a lateral view of a spacer element according to an exemplary embodiment of the present invention.

FIG. 4 shows a further lateral view of a spacer element according to an exemplary embodiment of the present invention.

FIG. 5 shows a top view of a spacer element according to an exemplary embodiment of the present invention.

FIG. 6 shows a top view of a cross section of a coaxial conductor according to an exemplary embodiment of the present invention.

FIG. 7 shows a longitudinal section A-A of a section of a coaxial conductor according to an exemplary embodiment of the present invention.

FIG. 8 shows an inner conductor with an installed spacer according to an exemplary embodiment of the present invention.

FIG. 9 shows an inner conductor with two spacer elements according to an exemplary embodiment of the present invention.

FIG. 10 shows an outer conductor of a coaxial conductor according to an exemplary embodiment of the present invention.

FIG. 11 shows a longitudinal section of a section of a coaxial conductor with a spacer that may be secured by means of two securing rings.

FIG. 12 shows a method for constructing a coaxial conductor according to an exemplary embodiment of the present invention.

### DETAILED DESCRIPTION OF EXEMPLARY EMBODIMENTS

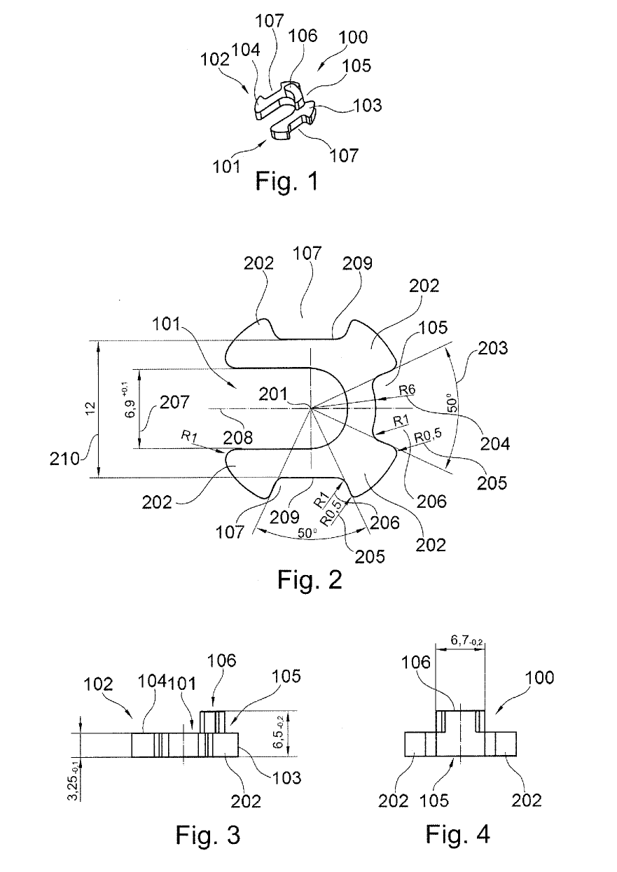

The illustrations in the figures are diagrammatic and not to scale. In the following description of FIGS. 1 to 12 the same reference characters are used for identical or corresponding elements.

FIG. 1 shows a diagrammatic three-dimensional view of a spacer element 100 according to an exemplary embodiment of the present invention. The spacer element 100 shows the U-shaped incision 101 and the circular plate 102 with a circular outside contour. The circular plate 102 comprises a thickness 103. Furthermore, the circular plate 102 comprises a surface region 104. The circular outside contour of the circular plate 102 is interrupted by the openings 105, 107 and by the U-shaped incision 101. The anti-rotation device 106 may be arranged on the semicircular region of the U-shaped incision 101. The anti-rotation device 106 may be arranged on the plate surface 104 and follows the course of the semicircular region of the U-shaped incision 101. In this arrangement the spacer element 100 and the anti-rotation device 106 may be made in one piece or integrally.

FIG. 2 shows a bottom view of the spacer element 100 from FIG. 1, according to an exemplary embodiment of the present invention. FIG. 2 shows support elements 202 whose edge regions form the outside contour of the spacer element 100, and which support elements are used to support the spacer element 100 on the inner sheath of the outer conductor of a coaxial conductor. These support elements 202 are arranged in the form of spokes. The outer edge of a support element 202 has a constant distance from the centre 201, which distance corresponds to the radius of the spacer element 100. Therefore, in relation to the centre 201, the outside contours describe a circle with an external radius. This external radius corresponds to the internal radius of the outer conductor of a coaxial line (not shown in FIG. 2). By means of the outside contour the spacer element may support itself on the inner sheath surface of the outer conductor of the coaxial conductor.

The spacer element 100 comprises two openings 107, which are arranged so as to be mirror-symmetrical in relation to the axis 208, and further comprises the opening 105, which is mirror-symmetrical in relation to the axis 208. The shape of the openings 105 at their lateral delimitation in radial direction follows the course of the limb of an angle 203 of 50 degrees. The limbs radiate outwards from the centre 201. In the direction of the U-shaped incision 101 the opening 105 is delimited by a circular ring segment with an inside contour, which circular ring segment comprises an external radius 204 of 6 mm.

The radii 205 at the transition from the opening 105, 107 to the outside contours of the support elements 202 comprise a radius of 0.5 mm. The radius 206 at the transition from the inside contour to the radially outward extending limbs comprises a radius of 1 mm.

The width 207 of the opening of the U-shaped incision 101 comprises a width 207 of 6.9 mm. The spacer element 101 is axially-symmetrical in relation to the axis 208.

The lateral inside contours 209 of the openings 107 extend parallel in relation to the symmetry axis 208. The spacing 210 of the two inside contours 209 from each other is 12 mm.

FIG. 3 shows a lateral view of a spacer element 100 according to an exemplary embodiment of the present invention. FIG. 3 shows the thickness 103 of the spacer element. This thickness is 3.25 mm. The anti-rotation device 106 is arranged on the plate surface 104 of the plate 102. The anti-rotation device extends to the inside contour of the opening 105, which in the lateral view of FIG. 3 is covered up by the support element 202 arranged in a spoke-shaped manner. As a result of this, the anti-rotation device 106 appears offset in the direction of the U-shaped incision 101. The contour of the anti-rotation device 106 follows the course of the circular section of the U-shaped incision 101. The anti-rotation device 106 is arranged such that in each case it may engage the U-shaped incision 101 of a further spacer element 101.

FIG. 4 shows a further lateral view of a spacer element 100 with a view onto the opening 105 according to an exemplary embodiment of the present invention. In this view, the spoke-shaped outside contours 202 which form the left-hand and right-hand delimitations of the opening 105 are shown. Also shown is the anti-rotation device 106 that is arranged on the spacer element 100. The overall thickness of the spacer element 100 is made up by the plate thickness and the thickness of the anti-rotation device; said overall thickness is 6.5 mm.

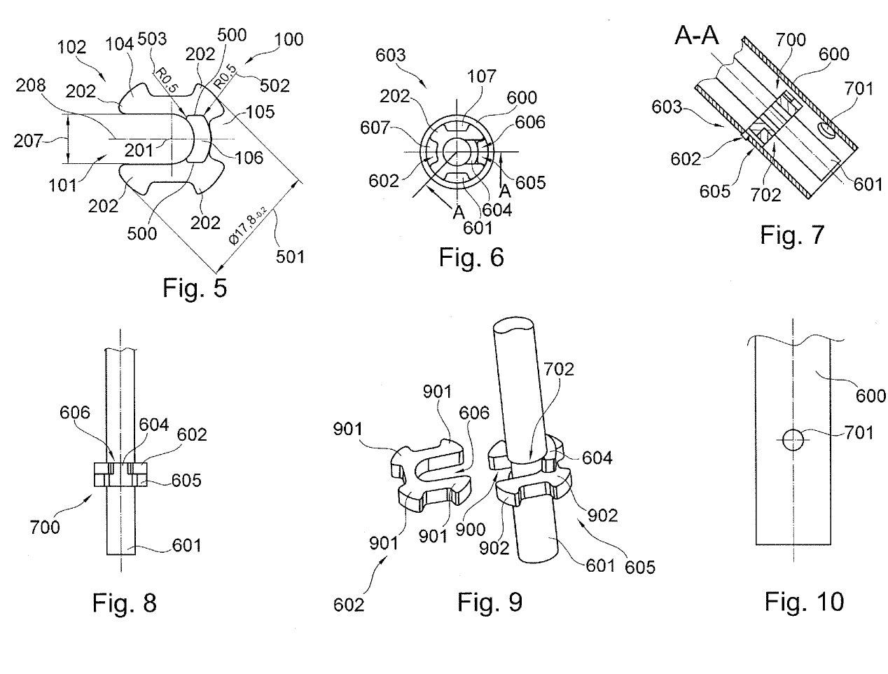

FIG. 5 shows a top view of a spacer element 100 according to an exemplary embodiment of the present invention. FIG. 5 shows the arrangement of the anti-rotation device 106 between the opening 105 and the U-shaped incision 101. The anti-rotation device 106, too, is arranged so as to be axially symmetrical, in relation to the symmetry axis 208, on the spacer element.

The sides 500 of the anti-rotation device 106 extend parallel in relation to the symmetry axis 208, and the distance between the two sides 500 corresponds to the width 207 of the U-shaped incision 101 so that, when the surface regions 104 of two plates 102 are located one on top of the other, in each case the anti-rotation devices 106 engage the U-shaped incision 101 of the other spacer element.

The diameter 501 of the outside contours is 17.8 mm. The associated radius corresponds to the internal radius of the outer conductor of a coaxial conductor (not shown in FIG. 5). The radius 502 of the side of the anti-rotation device 106, which side faces away from the U-shaped region, is 0.5 mm. The radius 503 of the transition from the parallel sides 500 to the inside contour of the anti-rotation device 106 is 0.5 mm. The four support elements 202 form the diameter 501 and support the spacer element 100 against the internal surface area of the coaxial conductor.

FIG. 6 shows the cross section of a coaxial conductor according to an exemplary embodiment of the present invention. The inside conductor 601 of the coaxial guide is concentrically arranged within the outer conductor 600 or tube 600. By means of the support elements 202 the inner conductor 601 is supported against the internal surface area of the tube 600 because the outside contour of the support elements 202 comes to rest against the internal surface area of the outer conductor 600.

The inner conductor 601 is located in the U-shaped incision 606 of the spacer element 602. The openings 607 of the spacer element 602 make it possible for materials such as liquids or bulk products to be distributed in the interior of the coaxial line 603. Furthermore, the anti-rotation device 604 of the spacer element 605 that is located below the spacer element 602 is shown. The support elements of the spacer element 605 are not visible because they are in alignment with the support elements 202. Because of the U-shaped opening 606 the spacer element 602 would make it possible for the inner conductor 601 to move outside the U-shaped opening 606.

This movement is prevented by means of the anti-rotation device 604, and in particular by means of the circular region of the spacer element 605. To this effect in FIG. 6 in the installed state of the coaxial conductor the spacer elements 602 and 605 have been brought into alignment. Likewise, the spacer element 605 would make it possible for the inner conductor 601 to move in the direction of the U-shaped incision (not visible) of the spacer element 605. In FIG. 6 this would be in the direction of the left-hand side. However, this movement option is prevented by the semicircular region of the spacer element 602.

The two spacer elements 602 and 605 thus complement each other such that a movement of the inner conductor 601 is prevented in all spatial directions on a plane defined by the spacer elements 602 and 605.

FIG. 7 shows a longitudinal section, according to the section line A-A of FIG. 6, of a section of a coaxial conductor 603 according to an exemplary embodiment of the present invention. The coaxial conductor 603 is supported by the spacers 700 at locations that recur in longitudinal direction. In particular the inner conductor 601 is supported against the outer conductor 600 so that the space between the inner conductor 601 and the outer conductor 600 remains constant over the course of the coaxial conductor 603.

In this arrangement the spacer 700 is arranged such that the circular opening 701 is not covered up by the spacer 700. This is achieved in that the inner conductor 601 comprises a groove 702, in which the spacer 700 is arranged. In this arrangement the length of the groove corresponds to the thickness of the sum of the thicknesses of the plates of the two spacer elements 602 and 605.

FIG. 8 shows the inner conductor 601 with the two spacer elements 602 and 605 according to an exemplary embodiment of the present invention. The figure shows the way the anti-rotation device 604 engages the U-shaped section 606 of the spacer element 602. Also shown is the way the spacer elements 602 and 605 complement each other to form the spacer 700 that supports the inner conductor 601 against the outer conductor 600 (not shown in FIG. 8).

FIG. 9 shows an inner conductor with two spacer elements 602, 605 according to an exemplary embodiment of the present invention. FIG. 9 shows the inner conductor 601 on which the spacer element 605 is already arranged in the groove 702. The thickness of the anti-rotation device 604 corresponds to the thickness of a plate of the spacer element 602, 605. In this way the sum of the thickness of the anti-rotation device 604 and the thickness of the plate of a spacer element determines the thickness of a spacer.

FIG. 9 also shows the spacer element 602 before it is laterally slid onto the inner conductor 601. When the spacer element 602 is slid on, the U-shaped incision 606 and the already installed spacer element 605 may serve as a guide.

During installation the anti-rotation device 604 engages the U-shaped incision 606. The anti-rotation device of the spacer element 602, which anti-rotation device engages the U-shaped incision 900 of the spacer element 605, is not visible in FIG. 9. In this way rotation of the two spacer elements 602 and 605 relative to each other is prevented. After installation the support elements 901 and 902 are in alignment. The groove 702 prevents displacement of the spacer elements 602, 605 in axial direction of the inner conductor 601 and facilitates insertion of the inner conductor with the spacer into the outer conductor.

FIG. 10 shows the outside of an outer conductor 600 of a coaxial conductor. Also shown is the circular opening 701 in the sheath of the coaxial outer conductor 600, which makes possible the passage from the outside of the coaxial conductor to the interior of the coaxial conductor.

A coaxial conductor may comprise a multitude of openings, as a result of which the propagation of material into the interior of the coaxial conductor is improved.

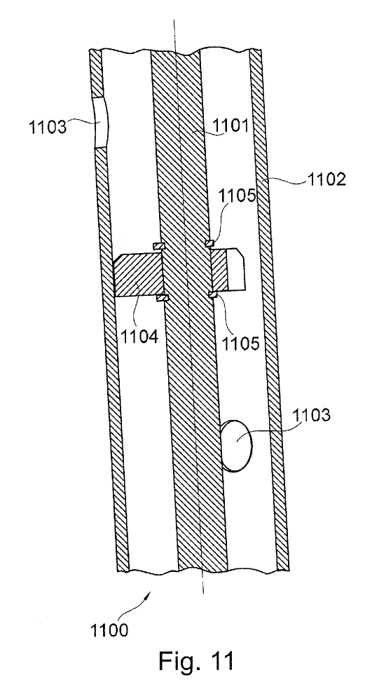

To provide a better understanding of the present invention, FIG. 11 shows a longitudinal section of a section of a coaxial conductor 1100 with a spacer 1104. The spacer 1104 is secured by means of two securing rings 1105. The spacer 1104 has been produced in a single piece, and the inner conductor 1101 does not comprise a groove in which the spacer may come to rest. The spacer 1104 thus rests directly against the inner conductor 1101 and against the outer conductor 1102 in order to ensure that the distance is maintained.

In order to prevent axial displacement of the spacer 1104, and in particular in order to prevent the spacer 1104 from covering up the inflow openings 1103, the spacer 1103 is held in position by means of the securing rings 1105.

With the use of the coaxial line according to the invention there is no need to provide securing rings, and consequently the production of the coaxial line may be simplified.

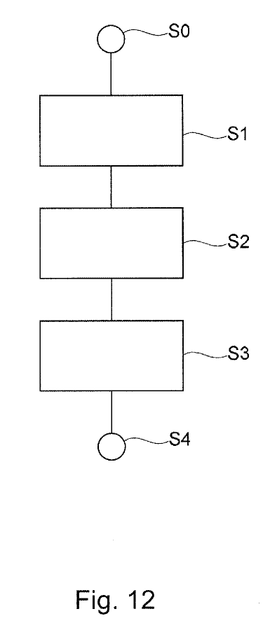

FIG. 12 shows a method for constructing a coaxial conductor according to an exemplary embodiment of the present invention. The method starts at the starting point S0. First, as described in step S1, a first spacer element is affixed to an inner conductor. Thereafter, in step S2, a second spacer element is affixed to the inner conductor such that the circular outside contours of the spacer elements are in alignment or complement each other such that movement of the inner conductor in any spatial direction is prevented when the inner conductor including the spacer elements is installed in the outer conductor.

Furthermore, the second spacer is arranged such that the inner conductor comes to rest in the semicircular region of the U-shaped incisions of the spacer elements. Due to the U-shaped incisions, affixing the spacers may take place by simple sliding-on action. No elastic deformation of the spacer element is required for installation. Consequently it is also possible to manufacture the spacer element from an inelastic material, for example a ceramic material.

Thereafter, as described in step S3, the inner conductor with the spacer elements is inserted into an outer conductor such that the spacer elements are kept together by means of the outer conductor and are prevented from being displaced in radial direction. The spacer elements are thus mutually stabilised.

The method ends at end point S4 with a finished coaxial conductor.

In addition, it should be noted that “comprising” and “having” does not exclude other elements or steps, and “a” or “one” does not exclude a plural number. Furthermore, it should be noted that characteristics or steps which have been described with reference to one of the above exemplary embodiments may also be used in combination with other characteristics or steps of other exemplary embodiments described above. Reference characters in the claims are not to be interpreted as limitations.

1. A spacer element for a spacer for a coaxial inner conductor for a fill-level measuring device, comprising:
a plate with a circular outside contour and a U-shaped incision,
wherein the circular outside contour has an external radius, the U-shaped incision having a semicircular region with an internal radius, the plate having a surface region, the outside contour and the U-shaped incision being so that when at least two spacer elements are arranged such that the circular outside contours are essentially in alignment and such that in each case a surface region of a plate rests against a surface region of the other plate, a spacer with a circular opening is formed, which opening has the internal radius of the semicircular region, and
wherein the outside contour and the opening form concentric circles.

2. The spacer element according to claim 1, wherein the plate has a thickness which is not greater than the external radius.

3. The spacer element according to claim 1, wherein the plate has a further opening.

4. The spacer element according to claim 3, wherein the further opening is arranged such that when a multitude of spacer elements are arranged together, the further opening forms a passage through the formed spacer.

5. The spacer element according to claim 3, wherein the further opening is arranged in an edge region of the spacer element.

6. The spacer element according to claim 1, further comprising:
an anti-rotation device arranged on the circular region of the U-shaped incision such that when the multitude of plates are arranged one on top of the other said anti-rotation device engages the U-shaped incision of the respective other plate such that any rotation of the multitude of plates relative to each other is essentially prevented.

7. The spacer element according to claim 1, wherein the spacer element is a mirror-symmetrical.

8. The spacer element according to claim 1, wherein the spacer element is made from a material with a relative permittivity εᵣ in a range between 1.5 and 80.

9. The spacer element according to claim 1, wherein the circular outside contour is formed by means of four segments of a circle.

10. The spacer element according to claim 1, wherein the internal radius corresponds to the external radius of an inner conductor.

11. The spacer element according to claim 1, wherein the fill-level measuring device is selected from the group comprising a fill-level measuring device that operates according to the time domain reflectometry method; a capacitive fill-level measuring device; a fill-level measuring device for interface acquisition; and a level-detection measuring device.

12. A spacer for a coaxial inner conductor for a fill-level measuring device, comprising:
at least two spacer elements, each of the at least two spaces elements including a plate with a circular outside contour and a U-shaped incision, the circular outside contour having an external radius, the U-shaped incision having a semicircular region with an internal radius, the plate having a surface region, the outside contour and the U-shaped incision being so that when at least two spacer elements are arranged such that the circular outside contours are essentially in alignment and such that in each case a surface region of a plate rests against a surface region of the other plate, a spacer with a circular opening is formed, which opening has the internal radius of the semicircular region, the outside contour and the opening forming concentric circles,
wherein the at least two spacer elements are arranged such that the circular external diameters are essentially in alignment,
wherein in each case a surface region of a plate of rests against the surface regions of the other plate, and
wherein the semicircular regions of the plates form a circular opening that is concentric in relation to the outside contour.

13. A coaxial conductor for a fill-level measuring device, comprising:
a spacer including at least two spacer elements, each of the at least two spaces elements including a plate with a circular outside contour and a U-shaped incision, the circular outside contour having an external radius, the U-shaped incision having a semicircular region with an internal radius, the plate having a surface region, the outside contour and the U-shaped incision being so that when at least two spacer elements are arranged such that the circular outside contours are essentially in alignment and such that in each case a surface region of a plate rests against a surface region of the other plate, a spacer with a circular opening is formed, which opening has the internal radius of the semicircular region, the outside contour and the opening forming concentric circles, wherein the at least two spacer elements are arranged such that the circular external diameters are essentially in alignment, wherein in each case a surface region of a plate of rests against the surface regions of the other plate, and wherein the semicircular regions of the plates form a circular opening that is concentric in relation to the outside contour;
an outer conductor; and
an inner conductor,
wherein the inner conductor is held so as to be centred in the interior of the outer conductor using the spacer.

14. The coaxial conductor according to claim 13, wherein the outer conductor is tubular.

15. The coaxial conductor according to claim 13, wherein the inner conductor is a bar.

16. The coaxial conductor according to claim 13, wherein the at least two spacer elements are secured against radial displacement using the outer conductor.

17. The coaxial conductor according to claim 13, wherein the inner conductor has a groove.

18. The coaxial conductor according to claim 13, wherein the outer conductor has an opening.

19. The coaxial conductor according to claim 18, wherein the opening is arranged such that it is not covered by a spacer.

20. A method for constructing a coaxial conductor using at least two spacer elements, the at least two spacer elements including first and second spacer elements, comprising:
(i) affixing of a first spacer element to an inner conductor, the coaxial conductor including:
(a) a spacer which includes the at least two spacer elements, each of the at least two spaces elements including a plate with a circular outside contour and a U-shaped incision, the circular outside contour having an external radius, the U-shaped incision having a semicircular region with an internal radius, the plate having a surface region, the outside contour and the U-shaped incision being so that when at least two spacer elements are arranged such that the circular outside contours are essentially in alignment and such that in each case a surface region of a plate rests against a surface region of the other plate, a spacer with a circular opening is formed, which opening has the internal radius of the semicircular region, the outside contour and the opening forming concentric circles, wherein the at least two spacer elements are arranged such that the circular external diameters are essentially in alignment, wherein in each case a surface region of a plate of rests against the surface regions of the other plate, and wherein the semicircular regions of the plates form a circular opening that is concentric in relation to the outside contour;
(b) an outer conductor; and
(c) an inner conductor held so as to be centred in the interior of the outer conductor using the spacer;
(ii) affixing of a second spacer element to the inner conductor such that the circular outside contours of the spacer elements are in alignment, and that the inner conductor rests in the semicircular regions of the U-shaped incisions; and
(iii) inserting of the inner conductor with the spacer elements into an outer conductor such that using the outer conductor the spacer elements are prevented from being displaced in radial direction.
